(19) United States
(12) Patent Application Publication
(10) Pub. No.: US 2023/0049377 A1
(43) Pub. Date: Feb. 16, 2023

(54) METHOD FOR AUTHENTICATING A USER TERMINAL

(71) Applicant: Robert Bosch GmbH, Stutttgart (DE)

(72) Inventors: Soheil Gherekhloo, Lauffen Am Neckar (DE); Jan-Felix Van Dam, Huenxe (DE); Ralf Prenzel, Hildesheim (DE)

(21) Appl. No.: 17/884,217

(22) Filed: Aug. 9, 2022

(30) Foreign Application Priority Data
Aug. 13, 2021 (DE) 10 2021 208 914.3

(51) Int. Cl. H04W 12/069; H04W 12/71

(52) U.S. Cl. CPC H04W 12/069; H04W 12/71

(57) ABSTRACT

A method for authenticating a user terminal as a transmitter of a message transmitted in a wireless communication network having a plurality of spatially distributed user terminals, The message is transmitted from a first user terminal to at least one second and/or one third user terminal with the aid of a wireless communications connection. The message includes useful data, first user-terminal-specific and second user-terminal-specific authentication data. The first user terminal is authenticated as the transmitter of the message based on the first user-terminal-specific authentication data with the aid of the second user terminal, and/or based on the second user-terminal-specific authentication data with the aid of the third user terminal.

### CROSS REFERENCE

The present application claims the benefit under 35 U.S.C. § 119 of German Patent Application No. DE 10 2021 208 914.3 filed on Aug. 13, 2021, which is expressly incorporated herein by reference in its entirety.

### FIELD

The present invention relates to a method for authenticating a user terminal as a transmitter of a message, and to a computer program and a machine-readable memory medium on which the computer program is stored. A user terminal and a system having a plurality of user terminals are also subject matters of the present invention.

### BACKGROUND INFORMATION

Methods are available in the related art for controlling a platoon or vehicle convoy of commercial vehicles which are driving behind one another and are connected via a vehicle-to-vehicle communication, in which the distances between the individual commercial vehicles of the vehicle platoon or the platoon members are controlled to approximately 10 to 15 meters by an automated longitudinal control, so that the fuel consumption and the vehicle emissions of the vehicle platoon are reduced by a reduction of the aerodynamic drag. Since the distances between the vehicles of the vehicle platoon are considerably smaller than the safety distance currently mandated by law, safe driving requires an exchange of V2X communications messages between the vehicles.

In the V2X specification according to the Cooperative Intelligent Transport Systems (C-ITS), so-called CAMs (Cooperative Awareness Message) are defined, which include the position of a vehicle in the vehicle platoon and further information, for example. These messages are able to be read by all vehicles that have implemented the corresponding protocol. To enable a platoon, further messages may be required between the vehicles, e.g., vehicle platoon control messages (PCM) and vehicle platoon management messages (PMM).

While traveling in a platoon, each platoon member is able to cyclically transmit a PCM, which includes its current status, to all other platoon members at short time intervals. This PCM is encrypted so that only the platoon members are able to decode this message. The PCMs are meant to maintain and control the platoon and thus the speed of each platoon member. The PCM includes a time stamp, which is generated by the transmitter of the message.

The PMMs are transmitted in an event-based manner. Depending on the application case, they are partly encrypted. For example, the incorporation of a vehicle into the platoon is enabled by a defined join request and a join response PMM. The join request PMM is not encrypted, but the transmitting vehicle adds a signature and its authentication certificate to this message so that the receiving vehicle is able to verify this message based on the certificate.

The PCMs are transmitted in encrypted form as broadcast messages. That means that all recipients which are located within the transmission range receive the message, but only those that have the platoon key are able to decode these messages.

Conventionally, the PCM is encrypted only with the aid of the symmetrical group key of the platoon. A signature of the message is not provided. From the aspect of data security, only the integrity is therefore provided and a restricted authenticity, which means that it can only be verified that a platoon member has transmitted the message. However, it is not possible to determine the particular member that has transmitted the message.

An additional signature of the PCM is currently all but impossible when using the currently available processors, even when utilizing a hardware acceleration, because the latency time exceeds the setpoint value of 10 ms as the result of the additional signing of the message at the transmitter and the verification of the signature at the recipient.

For a smooth speed control of the vehicles in the platoon, preferably at least the three trailing vehicles should have the capability of receiving the PCM and of authenticating the transmitter.

### SUMMARY

According to a first aspect, the present invention relates to a method for authenticating a user terminal as a transmitter of a message transmitted in a wireless communication network having a plurality of spatially distributed user terminals.

According to a second aspect, the present invention relates to a corresponding first user terminal.

According to a third aspect, the present invention relates to a corresponding system.

According to a further aspect, the present invention relates to a computer program or a computer program product, to a machine-readable memory medium such as a semiconductor memory, a hard disk memory or an optical memory having the computer program.

Within the scope of the present invention, a communication network may be understood as a network which is made up of a plurality of user terminals and designed to establish a direct or indirect wireless communications connection or a direct or indirect radio link between the user terminals. The network may be set up to enable a direct communication or a direct exchange of messages between the user terminals. The network may also include a base station or multiple base stations that allow(s) for an indirect communication between the user terminals via the one or the plurality of base station(s). For example, the communication network is designed to enable a communications connection according to the IEEE 802.11p standard, a near-field communications connection or a mobile radio connection, in particular a 5G mobile radio connection, between the user terminals. The communication network preferably includes a network of vehicle-side user terminals.

According to an example embodiment of the present invention, the communication network includes the first, the second and/or the third user terminal. The communication network preferably includes one or more further user terminals, and the message includes further user-terminal-specific authentication data in each case, in particular for none or for only a subset of the further user terminals.

The user terminal may be a user terminal or user equipment. The user terminal is preferably a vehicle-side user terminal. The user terminal may include a processor unit and a memory medium. In addition, the user terminal may include an antenna or be allocated to an antenna for transmitting the message with the aid of the wireless communications connection.

The message transmitted from the first user terminal to at least the second and/or the third user terminal is preferably transmitted with the aid of a radio signal. The message may be a periodically transmitted message in which at least the useful data of the message differ from transmission to transmission. In addition, the message may be a broadcast message or a message that is transmitted to all user terminals of the communication network, in particular user terminals located within a predefined range. The message may be a vehicle-platoon control message, PCM, for instance.

The useful data included in the message may be data of the first user terminal, in particular data pertaining to a vehicle that includes the first user terminal. For example, the user data can be current or future movement data of the first user terminal or of the vehicle which includes the first user terminal.

According to an example embodiment of the present invention, the user-terminal-specific authentication data that are included in the message are preferably pairwise authentication data specific to a user terminal. The user-terminal-specific authentication data in particular are transmitter-receiver-specific authentication data. In other words, the user-terminal-specific authentication data are preferably assigned to a pair of user terminals, i.e., two user terminals, or allow for an exchange of a message for a pair of user terminals or two user terminals in which one of the two user terminals can be verified as the transmitter of the message by the other of the two user terminals, in particular without the use of an asymmetrical cryptography system, especially a digital signature method for signing the message. The authentication data are generated based on an item of information or multiple items of information, in particular a user-terminal-specific symmetrical key and/or a user-terminal-specific allocation function, which is at least partly known only to the respective user terminals, or which was/were exchanged in encrypted and/or signed form only between the respective user terminals, especially using an asymmetrical encryption method.

The message preferably includes a predefined maximum number of N, e.g., N = 2 or N = 3, user-terminal-specific authentication data, in particular also in the case of a communication network that has more than N+1 user terminals or a vehicle platoon that has more than N+1 vehicles or vehicle-side user terminals.

The useful data and authentication data in the message are preferably arranged in the useful data, authentication data sequence in the message. The authentication data in the message are preferably arranged in the order or sequence of first authentication data, second authentication data.

The method according to the present invention provides a manipulation-proof and at the same time efficient method for authenticating a user terminal as a transmitter of a message transmitted to a plurality of user terminals. The method is particularly suitable for time-critical applications in which messages must be transmitted in a reliable manner with a very low latency time by way of a wireless communications connection, e.g., a platooning of vehicles. In particular when a predefined latency time does not permit a transmission of a message including a transmitter-side step of signing the message by a signature and a receiver-side step of verifying the signature, the provided method nevertheless allows for a secure communication in which the message is able to be received by a plurality of user terminals, and the transmitter of the message is also able to be authenticated by a plurality of user terminals. This makes it possible to reliably protect safety-critical applications or functions based on wirelessly transmitted messages, e.g., a speed control of trailing vehicles in a platoon, from manipulations by third parties.

According to an example embodiment of the present invention, it is advantageous if the content of the first user-terminal-specific authentication data and the second user-terminal-specific authentication data of the message depends on a spatial placement, in particular a position, of the user terminals relative to the first user terminal. The spatial placement may include a spatial position and/or a spatial distance, especially along a predefined direction, and/or a spatial formation, in particular a spatial order, of the user terminals relative to the first user terminal.

The first user-terminal-specific authentication data are preferably specific to a pair of user terminals that includes the first user terminal and the user terminal spatially closest to the first user terminal, in particular along a predefined direction such as counter to a driving direction. The second user-terminal-specific authentication data are preferably specific to a pair of user terminals that includes the first user terminal and the user terminal spatially second closest to the first user terminal, in particular along the same predefined direction. The third and/or fourth user-terminal-specific authentication data are preferably specific to a pair of user terminals that includes the first user terminal and the user terminal spatially third closest or fourth closest to the first user terminal, in particular along the same predefined direction.

It is also possible that the message includes further user-terminal-specific authentication data for a pair of user terminals that includes the first user terminal and the user terminal spatially next to the first user terminal, in particular counter to the same predefined direction.

It is furthermore possible that the message does not include any user-terminal-specific authentication data for a pair of user terminals that includes the first user terminal and a user terminal that does not satisfy a predefined positioning criterion, in particular with regard to a predefined direction, relative to the first user terminal. It is furthermore possible that the message does not include any user-terminal-specific authentication data for a pair of user terminals that includes the first user terminal and a user terminal that exceeds a predefined spatial distance relative to the first user terminal, in particular along a predefined direction.

This development may give the receiver of the message the possibility of authenticating the transmitter of the message while taking the positioning of the user terminals into account, with the result that an optimum is achievable between a high manipulation security of the message and a low channel utilization of the communication network.

It is advantageous in this context if the spatial positioning of the user terminals represents a positioning of vehicles which are driving one behind the other along a common driving direction and include a user terminal in each case. In other words, the user terminals are vehicle-side user terminals. The message preferably includes user-terminal-specific authentication data only for the user terminals included by the particular vehicles that directly follow the vehicle which includes the first user terminal along the common driving direction, it being preferred if the message maximally includes a predefined number of authentication data.

The first vehicle-side user terminal may be allocated to, in particular mounted on, a lead vehicle or a vehicle nearest to the front along the common driving direction. It is also possible that the first vehicle-side user terminal is allocated to a following vehicle, or to a vehicle following at least one further vehicle of the system of vehicles or is mounted thereon. The second vehicle-side user terminal is preferably allocated to or situated on a spatially next vehicle following, in particular directly or counter to the common driving direction, the vehicle having the first vehicle-side user terminal. The third vehicle-side user terminal is preferably allocated to or situated on a following vehicle, spatially next to, in particularly directly or counter to the common driving direction, the vehicle having the second vehicle-side user terminal.

The formation of vehicles may particularly be a vehicle convoy or platoon of vehicles on a common driving route. The vehicle platoon can be a vehicle column or a vehicle convoy. It is possible that the vehicle platoon is a formation of vehicles traveling behind one another. In other words, the vehicles of the vehicle platoon are designed to travel behind one another in a defined vehicle order, especially without a mechanical connection, i.e., using what is known as an “electronic tow bar”, between the vehicles. The vehicles are connected to one another by a wireless communications connection.

The vehicles of the vehicle platoon are able to drive behind one another separated by a very small spatial distance, preferably a distance of less than or equal to 50 m, especially preferably of less than or equal to 20 m, in order to reduce a fuel consumption or a conversion of electrical energy into kinetic energy as the result of the reduced aerodynamic drag or the reduced aerodynamic resistance force of the vehicles in the vehicle platoon. It is possible that one, a plurality, or all vehicles of the vehicle platoon is/are developed for an autonomous operation, in particular for autonomous driving. The vehicles are able to be controlled in a semiautomated, highly automated or fully automated manner.

A first vehicle or lead vehicle of the vehicle platoon driving in front of the other vehicles of the vehicle platoon is preferably a semiautomated or fully automated vehicle. The vehicles of the vehicle platoon following a first vehicle of the vehicle platoon traveling ahead are preferably fully automated vehicles. To this end, at least the vehicles of the vehicle platoon following the vehicle traveling in front or lead vehicle have a driver assistance system that provides longitudinal guidance and is designed to automatically control or regulate a distance in the driving direction between a following vehicle and a vehicle traveling directly in front of the following vehicle, in particular based on messages transmitted between the vehicles according to the provided method.

Because of this development, a communication for the positioning of the vehicles driving behind one another along the common driving direction is able to be ensured at a particularly low latency and at the same time with a high manipulation security, thereby allowing the vehicles to drive one behind the other at a spatial distance of less than or equal to 20 m, for instance, or at a time interval of less than or equal to 0.8 s between two of the vehicles in each case.

According to an example embodiment of the present invention, it is also advantageous if the first user-terminal-specific authentication data and/or the second user-terminal-specific authentication data are generated using a symmetrical key supplied to two user terminals in each case, and furthermore in particular using the useful data, most preferably using a portion of the useful data. The first user-terminal-specific authentication data are able to be generated using the symmetrical key known to the first user terminal and the second user terminal or exchanged in encrypted and/or signed form between the first user terminal and the second user terminal, especially using an asymmetrical encryption method, and preferably with partial or complete use of the useful data. The second user-terminal-specific authentication data are able to be generated using the symmetrical key known to the first user terminal and the third user terminal or using the symmetrical key exchanged, especially in encrypted and/or signed form, between the first user terminal and the third user terminal, in particular using an asymmetrical encryption method, and preferably with a partial or complete use of the same useful data. Because of this development, an especially manipulation-proof method is able to be provided.

According to an example embodiment of the present invention, it is advantageous, in particular, if the first user-terminal-specific authentication data and/or the second user-terminal-specific authentication data include a message authentication code (MAC) specific to a user terminal. The user-terminal-specific message authentication code, for example, is able to be generated using an HMAC-SHA256 method. It is possible that the user-terminal-specific message authentication code included by the user-terminal-specific authentication data of the message is an abbreviated or reduced message authentication code. To this end, the message authentication code is able to be ascertained based on a partial set or a subset of the useful data. The partial set or subset of the useful data used for ascertaining the message authentication code, for example may be the particular subset of the useful data that is relevant for the driving safety and/or the communications security of vehicle-side user terminals. Because of this embodiment, it is possible, in particular given a brief time validity or relevance of the useful data of the message, to provide a manipulation-proof method which simultaneously features a reduced channel utilization. The search space such as for a brute-force attack is reduced by the shortening of the MACs, but there is insufficient time for an attacker to successfully falsify the MACS in view of a very short validity of the message.

As an alternative or in addition, it is advantageous if the message also includes a random value, and the first user-terminal-specific authentication data and/or the second user-terminal-specific authentication data include a user-terminal-specific function value of an in particular user-terminal-specific allocation function based on the random value. The function value corresponds to an output value of the allocation function for the random value as an input value. The first user-terminal-specific authentication data are able to be generated using the allocation function known to the first user terminal and the second user terminal or exchanged in encrypted and/or signed form between the first user terminal and the second user terminal, in particular with the aid of an asymmetrical encryption method, and using the random value. The second user-terminal-specific authentication data are able to be generated using the allocation function known to the first user terminal and the third user terminal or exchanged in encrypted and/or signed form between the first user terminal and the third user terminal, in particular with the aid of an asymmetrical encryption method, and using the same random value. Because of this embodiment, an especially rapid authentication method from the aspect of the computer processing time and at the same time a secure authentication method is able to be provided.

According to an example embodiment of the present invention, it is also advantageous if the useful data of the message or the message is/are encrypted using a key provided to the user terminals of the communication network. It is possible that the message is transmitted to further user terminals to which the key for decrypting the useful data or the message is not provided. Because of this embodiment, the messages can be decrypted only by a defined group of user terminals to further increase the security of the communication.

According to an example embodiment of the present invention, it is furthermore advantageous if the second and/or third user terminal and/or a second vehicle including the second user terminal, and/or a third vehicle including the third user terminal is/are controlled based on the transmitted message. The control of the vehicle, for example, may be a control of one or more unit(s) selected from the drive unit, brake unit, steering unit, and/or display unit of the vehicle. The control of the unit or units is preferably implemented on the useful data of the transmitted message.

A control of the drive unit and/or the brake unit with the aid of the control signal may include increasing, maintaining or lowering a drive power and/or a brake power and/or a driving speed. It is possible that the useful data include an item of information about an initiated braking operation or a braking operation to be initiated of the vehicle that includes the first user terminal. For this purpose, the drive unit and/or the brake unit is/are able to be actuated in such a way that the spatial distance between the vehicles is not significantly reduced.

An actuation of the display unit may include a display of a required dissolution of the vehicle platoon and/or an enlargement or a reduction of the distance between the vehicles with the aid of the display unit. A control of the user terminal may initiate a transmittal of a further message. Because of this embodiment, the user terminals and the vehicles are able to be operated in a manipulation-proof manner.

According to an example embodiment of the present invention, it is furthermore advantageous if the message is transmitted from the first user terminal to a fourth and a fifth user terminal of the wireless communication network, the message furthermore including third user-terminal-specific authentication data, and, alternatively or additionally, the first user terminal being authenticated as the transmitter of the message based on the third user-terminal-specific authentication data with the aid of the fourth user terminal. In addition, the message may include fourth user-terminal-specific authentication data and, alternatively or in addition, the first user terminal is able to be authenticated as the transmitter of the message based on the fourth user-terminal-specific authentication data with the aid of the fifth user terminal. Because of this embodiment, the manipulation security of the communication is able to be expanded to further user terminals of the communication network.

### BRIEF DESCRIPTION OF THE DRAWINGS

Below, the present invention is described in greater detail by way of example based on the figures.

FIG. 1 shows a communication network having five vehicle-side user terminals, according to an example embodiment of the present invention.

FIG. 2 shows a flow diagram of a method in an incorporation of a further user terminal into a communication network, according to an example embodiment of the present invention.

FIGS. 3A and 3B each show a schematic illustration of the structure of a message according to an example embodiment of the present invention.

FIG. 4 shows a flow diagram of a method for authenticating a user terminal as a transmitter of a message according to an example embodiment of the present invention.

### DETAILED DESCRIPTION OF EXAMPLE EMBODIMENTS

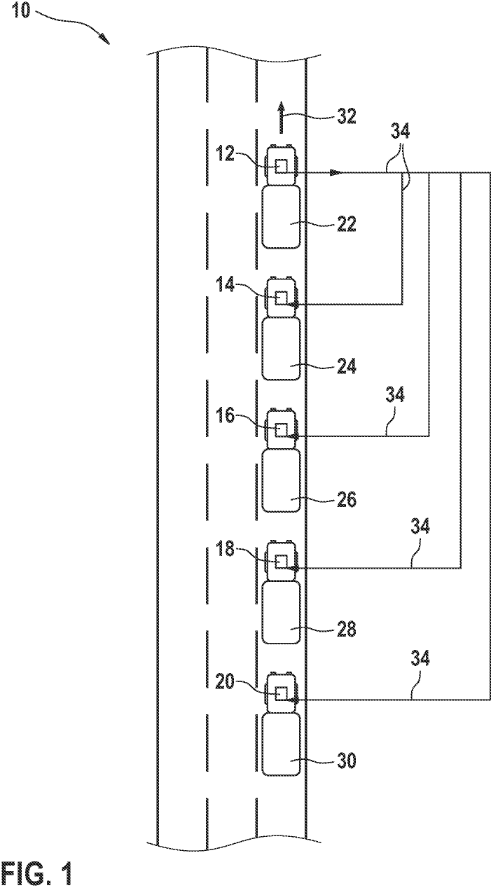

FIG. 1 shows a communication network 10, which includes a first user terminal 12, a second user terminal 14, a third user terminal 16, a fourth user terminal 18, and a fifth user terminal 20. User terminals 12, 14, 16, 18, 20 are developed as vehicle-side user terminals 12, 14, 16, 18, 20 and disposed on a vehicle 22, 24, 26, 28, 30 in each case. Vehicles 22, 24, 26, 28, 30 are developed as trucks 22, 24, 26, 28, 30 and travel one behind the other along a common driving direction 32.

Each user terminals 12, 14, 16, 18, 20 at least includes a processor unit and a memory medium. In addition, a vehicle-side antenna is allocated to user terminal 12, 14, 16, 18, 20.

User terminals 12, 14, 16, 18, 20 are set up to exchange messages 34, directly or indirectly, with the aid of a wireless communications connection. User terminals 12, 14, 16, 18, 20 are preferably designed for a mobile radio communication such as 3G, 4G or 5G, for a C-V2X communication or for an ITS-G5 communication.

According to the present exemplary embodiment, user terminals 12, 14, 16, 18, 20 are developed as V2X control units 12, 14, 16, 18, 20. User terminals 12, 14, 16, 18, 20 are connected with the aid of a wired communications connection, in particular a CAN connection, to a vehicle-side control unit for a speed control of respective vehicle 22, 24, 26, 28, 30 in each case. In addition, user terminals 12, 14, 16, 18, 20 may be connected by a wired communications connection, in particular a CAN connection, to a vehicle-side HMI control unit to represent information for a driver of respective vehicle 22, 24, 26, 28, 30.

In addition, user terminals 12, 14, 16, 18, 20 or V2X control units 12, 14, 16, 18, 20 are preferably also designed for a wireless communication with a road communications device or an infrastructure device (known as roadside) and optionally also with a vehicle-external server unit.

The control units for controlling the speed are designed to ascertain and/or to control or adjust a setpoint speed, in particular while actuating a drive unit and/or a brake unit of the respective vehicle. The control units for a speed control may also be designed to establish the driving strategy, e.g., with the aid of an electronic horizon.

According to a preferred embodiment of the present invention, a platooning software is stored or installed on a memory unit allocated to the respective user terminal 12, 14, 16, 18, 20. The platooning software enables communications-based trailing of vehicles 22, 24, 26, 28, 30, such as on a highway, e.g., an expressway, at a spatial distance of less than or equal to 50 m, in particular less than or equal to 20 m, or at a time interval of less than or equal to 2 seconds, in particular less than or equal to 0.8 seconds, between two of the vehicles in each case.

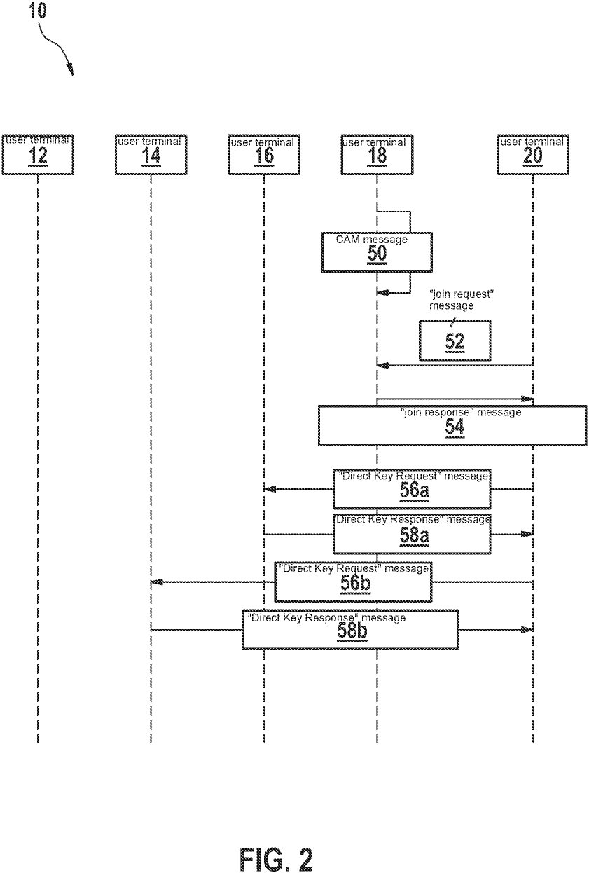

FIG. 2 shows a method for transmitting messages when incorporating a further user terminal into a communication network.

According to a preferred embodiment, vehicles 22, 24, 26, 28 according to FIG. 1 already form a vehicle convoy or platoon to which vehicle 30 is added.

Vehicle-side user terminal 18 of the last vehicle 28 of communication network 10 in the driving direction transmits a message 50 to at least vehicle 30, in particular a CAM message 50 developed as a broadcast message 50, to vehicles 22, 24, 26,

30. This message includes an item of information, e.g., the information including, “Joinable = yes”, based on which vehicles 22, 24, 26, 30 recognize that vehicle 28 is the last vehicle of the vehicle platoon.

Vehicle 30 approaches vehicles 22, 24, 26, 28 from behind. Vehicle-side user terminal 20 transmits a “Join Request” message 52 to vehicle-side user terminal 18 with the aid of the wireless communications connection. This “Join Request” message 52 includes a station ID of vehicle-side user terminal 20 and a certificate of vehicle-side user terminal 20.

Via the wireless communications connection, vehicle-side user terminal 18 transmits a “Join Response” message 54 to vehicle-side user terminal 20 to confirm the addition of vehicle 20 to the platoon of vehicles 22, 24, 26, 28. Vehicle-side user terminal 18 is designed to encrypt “Join Response” message 54 using a public key included in “Join Request” message 52. “Join Response” message 54 includes a group key already used for encrypting messages between vehicle-side user terminals 12, 14, 16, 18. “Join Response” message 54 furthermore includes a position, allocated to vehicle 30 to be added, in a spatial sequence of vehicles 22, 24, 26, 28.

In addition, “Join Response” message 54 encompasses a symmetrical key which is preferably generated by vehicle-side user terminal 18. Moreover, “Join Response” message 54 includes a list of vehicles 22, 24, 26, 28, in particular a list of tuples made up of a station ID of respective vehicle 22, 24, 26, 28 and its position within the platoon. It is thus known to user terminal 20 which vehicle 22, 24, 26, 28 is driving in which position in the platoon. It is possible that the list included in “Join Response” message 54 includes information pertaining only to the three last vehicles 24, 26, 28 in the driving direction.

Vehicle-side user terminal 20 is now designed to address a “Direct Key Request” message 56a, 56b to vehicle-side user terminals 14, 16 using the station ID of respective vehicle 24, 26 and to transmit it with the aid of the wireless communications connection.

This “Direct Key Request” message 56a, 56b is certified by vehicle-side user terminal 20 so that respective vehicle-side user terminal 14, 16 is able to verify the certificate. The “Direct Key Request” message 56a, 56b furthermore includes the position allocated to vehicle 30 in the platoon of vehicles 22, 24, 26, 28, 30. The “Direct Key Request” message 56a, 56b additionally includes a public key of vehicle-side user terminal 20.

Vehicle-side user terminals 14, 16 are designed to receive the “Direct Key Request” message 56a, 56b and to generate a symmetrical key in each case. Moreover, vehicle-side user terminals 14, 16 are designed to transmit a “Direct Key Response” message 58a, 58b to vehicle-side user terminal 20 in response to the received “Direct Key Request” message 56a, 56b. Each “Direct Key Response” message 58a, 58b includes the generated symmetrical key. In addition, “Direct Key Response” message 58a, 58b is encrypted using the public key of vehicle-side user terminal 20.

The following keys are made available to vehicle-side user terminals 14, 16, 18, 20:
Using the certificate of vehicle-side user terminal 20, verifiable public keys of vehicle-side user terminal 20 are supplied to vehicle-side user terminals 14, 16, 18.
The symmetrical group key already known to vehicle-side user terminals 12, 14, 16, 18 is provided to vehicle-side user terminals 20.
A symmetrical key is supplied to vehicle-side user terminals 18, 20, to vehicle-side user terminals 16, 20, and to vehicle-side user terminals 14, 20.

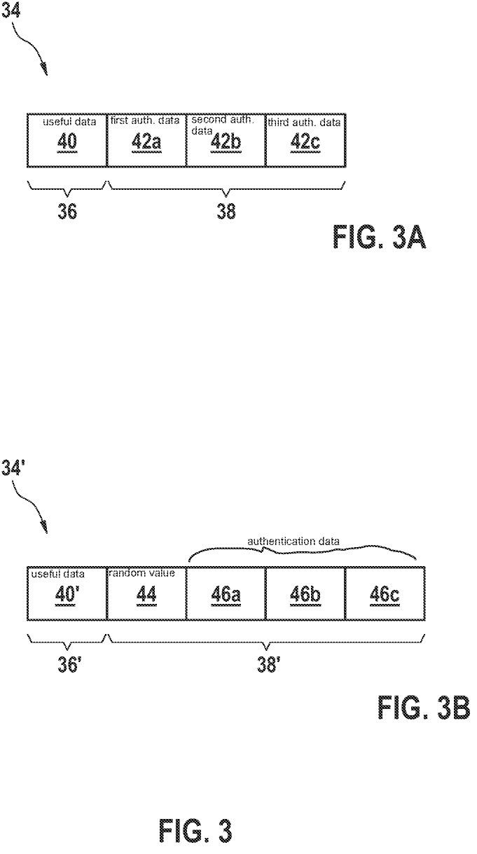

FIG. 3A, B show a schematic representation of the structure of a message 34, 34' transmitted in a communication network 10 according to FIG. 1. Message 34, 34', for example, may be a PCM or platooning control message 34, 34'.

In FIG. 3A, message 34 includes a first data block 36 and a second data block 38. First data block 36 includes useful data 40. Second data block 38 includes first authentication data 42a, second authentication data 42b, and third authentication data 42c. Authentication data 42a, 42b, 42c are developed as user-terminal-specific message authentication codes MAC2-3, MAC2-4, MAC2-5. User-terminal-specific message authentication codes MAC2-3, MAC2-4, MAC2-5 are generated using a symmetrical key provided to two vehicle-side user terminals in each case and utilizing useful data 40.

According to this exemplary embodiment, message 34 is generated by second vehicle-side user terminal 14 and transmitted to vehicle-side user terminals 12, 16, 18, 20 with the aid of the wireless communications connection. First user-terminal-specific message authentication code MAC2-3 is generated using the symmetrical key exchanged between vehicle-side user terminals 14, 16 as well as useful data 40. Second user-terminal-specific message authentication code MAC2-3 is generated using the symmetrical key exchanged between vehicle-side user terminals 14, 18 as well as useful data 40. Third user-terminal-specific message authentication code MAC2-4 is generated using the symmetrical key exchanged between vehicle-side user terminals 14, 20 as well as useful data 40.

In FIG. 3B, message 34' includes a first data block 36' and a second data block 38'. First data block 36' includes useful data 40'. Second data block 38' includes a random value 44, first authentication data 46a, second authentication data 46b, and third authentication data 46c. Authentication data 46a, 46b, 46c are developed as function values 46a, 46b, 46c of a user-terminal-specific allocation function F2-3, F2-4, F2-5. Function values 46a, 46b, 46c correspond to an output value of the respective user-terminal-specific allocation function F2-3, F2-4, F2-5 for random value 44 as an input value. If message 34' is transmitted in encrypted form, in particular encrypted using a group key, the integrity of message 34' is able to be verified based on the encryption. The authentication of message 34' is implemented based on random value 44.

According to this exemplary embodiment, message 34' is generated by second vehicle-side user terminal 14 and transmitted to vehicle-side user terminals 12, 16, 18, 20 with the aid of the wireless communications connection.

Function value 46a is generated using random value 44 and user-terminal-specific allocation function F2-3 exchanged between vehicle-side user terminals 14, 16. Function value 46b is generated using random value 44 and user-terminal-specific allocation function F2-4 exchanged between vehicle-side user terminals 14, 18. Function value 46c is generated using random value 44 and the user-terminal-specific allocation function F2-5 exchanged between vehicle-side user terminals 14, 20.

In addition, message 34, 34' or useful data 40, 40' of message 34, 34' is/are able to be encrypted using a group key supplied to vehicle-side user terminals 12, 14, 16, 18, 20 of communication network 10.

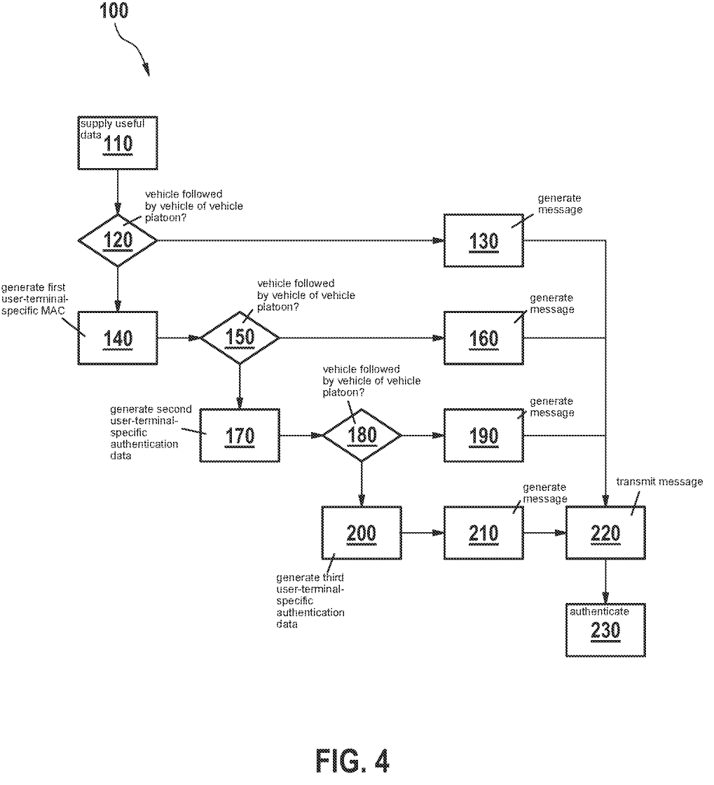

FIG. 4 shows a flow diagram of a method for authenticating a user terminal as a transmitter of a message, the method including steps for generating message 34 according to FIG. 3, e.g., in a communication network according to FIG. 1. The method has been provided with reference numeral 100 as a whole. For instance, method 100 is able to be carried out after executing the method for transmitting messages when incorporating a further user terminal into a communication network according to FIG. 2.

In step 110, useful data are supplied to the first user terminal.

In step 120, it is ascertained whether a vehicle of a vehicle platoon including the first user terminal is followed by a vehicle of a vehicle platoon including a second user terminal.

In the event that no vehicle of the vehicle platoon including a second user terminal is following the vehicle having the first user terminal, the message to be transmitted is generated in step 130. The message includes the supplied useful data. The message is encrypted using a compound key of the vehicle platoon.

In the event that the vehicle including the first user terminal is followed by a vehicle of the vehicle platoon including a second user terminal, then a first user-terminal-specific message authentication code is generated as first user-terminal-specific authentication data in step 140 with the aid of the first user terminal, using a first symmetrical key specific to the first and the second user terminal, and the useful data.

In step 150, it is ascertained whether the vehicle including the second user terminal is followed by a vehicle of the vehicle platoon including a third user terminal.

In the event that the vehicle including the second user terminal is not followed by a vehicle of the vehicle platoon including a third user terminal, the message to be transmitted is generated in step 160. The message includes the supplied useful data and the first user-terminal-specific message authentication code. The message is encrypted using the compound key of the vehicle platoon.

In the event that the vehicle having the second user terminal is followed by a vehicle of the vehicle platoon having a third user terminal, a second user-terminal-specific message authentication code is generated in step 170 as second user-terminal-specific authentication data with the aid of the first user terminal using a second symmetrical key specific to the first and the third user terminal, and the useful data.

In step 180, it is ascertained whether the vehicle having the third user terminal is followed by a vehicle of the vehicle platoon having a fourth user terminal.

In the event that no vehicle of the vehicle platoon having a fourth user terminal follows the vehicle having the third user terminal, then the message to be transmitted is generated in step 190. The message includes the supplied useful data as well as the first and second user-terminal-specific message authentication codes. The message is encrypted using the compound key of the vehicle platoon.

In the event that the vehicle having the third user terminal is followed by a vehicle of the vehicle platoon having a fourth user terminal, then a third user-terminal-specific message authentication code is generated in step 200 as third user-terminal-specific authentication data with the aid of the first user terminal, using a third symmetrical key specific to the first and fourth user terminal, and the useful data.

In step 210, the message to be transmitted is generated. The message includes the supplied useful data as well as the first, the second and the third user-terminal-specific message authentication code. The message is encrypted using a compound key of the vehicle platoon.

In step 220, the message is transmitted from the first user terminal to the further user terminals of the communication network, in particular to the further vehicle-side user terminals of the vehicle platoon.

In step 230, the first user terminal is authenticated as the transmitter of the message based on the user-terminal-specific authentication data. If step 220 follows step 160, the first user terminal is authenticated as the transmitter of the message based on the first user-terminal-specific message authentication code with the aid of the second user terminal. If step 220 follows step 190, the first user terminal is additionally authenticated as the transmitter of the message based on the second user-terminal-specific message authentication code with the aid of the third user terminal. If step 220 follows step 210, the first user terminal is additionally authenticated as the transmitter of the message based on the third user-terminal-specific message authentication code with the aid of the fourth user terminal.

The method may be carried out multiple times one after the other, preferably periodically, while the vehicle platoon is driving and in operation.

What is claimed is:

1. A method for authenticating a user terminal as a transmitter of a message transmitted in a wireless communication network having a plurality of spatially distributed user terminals, the message being transmitted from a first user terminal to at least one second user terminal and/or third user terminal using a wireless communications connection, the message including useful data, first user-terminal-specific authentication data, and second user-terminal-specific authentication data, the method comprising:
authenticating the first user terminal as transmitter of the message:
based on the first user-terminal-specific authentication data using the second user terminal, and/or
based on the second user-terminal-specific authentication data using the third user terminal.

2. The method as recited in claim 1, wherein a content of the first user-terminal-specific authentication data of the message and the second user-terminal-specific authentication data of the message depends on a spatial placement of the user terminals relative to the first user terminal.

3. The method as recited in claim 2, wherein the spatial positioning of the user terminals represents a positioning of vehicles driving one behind the other along a common driving direction each having a respective user terminal of the user terminals.

4. The method as recited in claim 1, wherein the first user-terminal-specific authentication data and/or the second user-terminal-specific authentication data are generated using a symmetrical key provided to two user terminals in each case, and also using the useful data.

5. The method as recited in claim 1, wherein the first user-terminal-specific authentication data and/or the second user-terminal-specific authentication data include a user-terminal-specific message authentication code.

6. The method as recited in claim 1, wherein the message further includes a random value, and the first user-terminal-specific authentication data and/or the second user-terminal-specific authentication data include a user-terminal-specific function value based on the random value.

7. The method as recited in claim 1, wherein the useful data of the message or the message is encrypted using a key provided to the user terminals of the communication network.

8. The method as recited in claim 1, wherein the second user terminal and/or the third user terminal and/or a second vehicle having the second user terminal and/or a third vehicle including the third user terminal, is controlled based on the transmitted message.

9. The method as recited in claim 1, wherein the message is transmitted from the first user terminal to a fourth user terminal and a fifth user terminal of the wireless communication network, and the message further includes third user-terminal-specific authentication data specific to the third user terminal, and the first user terminal is authenticated as the transmitter of the message based on the third user-terminal-specific authentication data using the fourth user terminal.

10. A first user terminal, configured to:
supply a message including useful data, first user-terminal-specific authentication data and second user-terminal-specific authentication data; and
transmit the message to at least one second user terminal and/or third user terminal, using a wireless communications connection.

11. A system, comprising:
a first user terminal configured to:
supply a message including useful data, first user-terminal-specific authentication data and second user-terminal-specific authentication data, and
transmit the message to at least one second user terminal and third user terminal, using a wireless communications connection; and
the at least one second and third user terminal;
wherein the second user terminal is configured to:
receive the message transmitted from the first user terminal to the second user terminal using the wireless communications connection, and
authenticate the first user terminal as a transmitter of the message based on the first user-terminal-specific authentication data; and wherein the third user terminal is configured to:
receive the message transmitted from the first user terminal to the third user terminal using the aid of the wireless communications connection, and
authenticate the first user terminal as the transmitter of the message based on the second user-terminal-specific authentication data.

12. A non-transitory machine-readable memory medium on which is stored a computer program which includes instructions that when executed by a first user terminal, induce the first user terminal to:
supply a message including useful data, first user-terminal-specific authentication data, and second user-terminal-specific authentication data; and
transmit the message to at least one second and/or one third user terminal, using a wireless communications connection.
